(19) United States
(12) Patent Application Publication
(10) Pub. No.: US 2025/0217762 A1
(43) Pub. Date: Jul. 3, 2025

(54) MOBILE DISPENSING ENCLOSURE WITH INVENTORY MANAGEMENT AND ACCESS CONTROL FUNCTIONALITY

(71) Applicant: Bhushan Kumud Shelat, Clermont, FL (US)

(72) Inventor: Bhushan Kumud Shelat, Clermont, FL (US)

(21) Appl. No.: 18/791,659

(22) Filed: Aug. 1, 2024

Related U.S. Application Data
(60) Provisional application No. 63/616,023, filed on Dec. 29, 2023.

(51) Int. Cl. G06Q 10/087; G01G 19/414

(52) U.S. Cl. CPC G06Q 10/087; G01G 19/4144

(57) ABSTRACT

A product vending system includes a product enclosure having a plurality of product compartments, each product compartment having a base supporting one or more products, wherein the plurality of product compartments is inaccessible from an exterior environment but for an opening in an open condition, and a roller door movable between the open condition and a closed condition preventing access to the plurality of product compartments. For each base, the product venting system provides a scale sensor operatively associating the base and an inventory management module adapted to continuously make a real-time determination of a quantitative change in the one or more products and maintain a database comprising the real-time determination.

### CROSS-REFERENCE TO RELATED APPLICATION

This application claims the benefit of priority of U.S. provisional application No. 63/616,023, filed 29 Dec. 2023, the contents of which are herein incorporated by reference.

### BACKGROUND OF THE INVENTION

The present invention relates to product dispensing systems and, more particularly, to a mobile product dispensing machine with inventory management and access control functionality.

“Inventory is money sitting around in another form. The trick is to turn it back into money as quickly as possible.”-Arthur Blank, Co-founder of The Home Depot™.

Traditional inventory management systems in the vending machine industry are suboptimal because of several key drawbacks. Specifically, traditional inventory management systems often fall short due to their lack of real-time insights, limited remote control capabilities, and absence of comprehensive features like UV-C disinfection and climate control, resulting in inefficiencies, security vulnerabilities, and challenges in maintaining optimal storage conditions for various products. For instance, traditional systems often rely on periodic manual checks or batch updates, leading to a lack of real-time visibility into inventory levels-without real-time data analysis and triggering. As a result, demand planning becomes challenging and businesses may struggle to adapt quickly to changing customer needs or trends as current approaches may miss irregularities in consumption patterns, making it difficult to identify and address issues such as unexpected spikes or declines in demand. Likewise, traditional vending systems may not seamlessly integrate with suppliers, distributors, or other partners, hindering collaborative efforts and impacting overall supply chain efficiency.

As can be seen, there is a need for a mobile product dispensing machine that seamlessly integrates real-time inventory insights, remote management, access control, UV-C disinfection, and optional climate control, providing an all-encompassing and superior approach to efficient, secure, and hygienic inventory management.

### SUMMARY OF THE INVENTION

The present invention embodies a smart cuboid cart providing supply solution with real-time inventory insights, remote management, and access control for optimal inventory optimization. The smart cuboid cart of the present invention features UV-C disinfection and optional temperature and humidity control, thereby offering a novel solution for products requiring specialized storage conditions.

The present invention combines these features in a single comprehensive solution, or cart assembly, to improve supply chain efficiency, security, and safety.

The present invention improves upon traditional inventory systems by providing real-time insights, remote management, access control, UV-C disinfection, and optional climate control, addressing the shortcomings of inefficiency, security vulnerabilities, and inadequate storage conditions, thereby offering a holistic and superior solution to modern inventory management challenges.

The present invention revolutionizes inventory management by offering real-time insights, remote control, and access restrictions, ensuring optimal inventory optimization and security. The integration of UV-C disinfection technology enhances hygiene, while the optional temperature and humidity control caters to specialized storage needs. This combined approach streamlines supply chain processes, mitigates risks, and sets a new standard for efficient and secure inventory management.

The value of the present invention lies in its ability to provide a tangible and practical solution for businesses or organizations seeking improved inventory management, hygiene maintenance, and controlled access within a mobile cart framework. The present invention, colloquially known as the ‘Smart Cuboid Cart is a product that incorporates various technologies to address specific challenges in the supply chain and storage processes.

In one aspect of the present invention, a product venting system includes the following: a product enclosure having a plurality of product compartments, each product compartment having a base supporting one or more products, wherein the plurality of product compartments are inaccessible from an exterior environment but for an opening in an open condition; and a roller door movable between the open condition and a closed condition preventing access to the plurality of product compartments; a processor; a memory, wherein the processor is communicatively coupled with the memory; for each base, a scale sensor operatively associating the base and the processor; and an inventory management module and wherein the processor is operable to: continuously make a real-time determination of a quantitative change in the one or more products, and maintain a database comprising the real-time determination.

In another aspect of the present invention, a related system includes the following: a product enclosure comprising: a plurality of product compartments, each product compartment supporting one or more products; a processor; a memory, wherein the processor is communicatively coupled with the memory; for each product compartment, a scale sensor configured to output a weight value indicative of a weight of the one or more product, operatively associating the base and the processor; and an inventory management module and wherein the processor is operable to: for each product compartment, generate a map of the one or more products compartment, wherein the map provides a location indication of each said product; continuously make a real-time determination of a quantitative change in the one or more products based on a change in the outputted weight value of one or more of the plurality of product compartments and an identification of each location indication associated with said change in the outputted weight value, and maintain a database comprising the real-time determination.

In yet another aspect of the present invention, the system further includes wherein the plurality of product compartments is inaccessible from an exterior environment but for an opening in an open condition; and a roller door movable between the open condition and a closed condition preventing access to the plurality of product compartments, wherein the product enclosure further comprises an authentication sensor operatively associated with the roller door such that movement to the open condition requires verification of the authentication sensor, wherein when the product enclosure is stocked with a product, the location indication and a unit weight of each product is received by the server as an inventory stocking data, wherein a summation, for each product compartment, of the unit weights for the one or more products is a baseline for the real-time determination of the change in the outputted weight value, wherein the real-time determination is based on the inventory stocking data, wherein the inventory management module is configured to track a level for each product, wherein the inventory management module is configured to forecast a future demand for each product based on the real-time determination, wherein the inventory management module is configured to plan a replenishment for each product based on the real-time determination and an inventory threshold for said product, wherein the inventory threshold is received by the server, and wherein the inventory management module is configured to transmit alerts for each product based on the real-time determination and the inventory threshold for said product.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention.

FIG. 2 is a flow chart of an exemplary embodiment of the present invention.

FIG. 3 is a perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

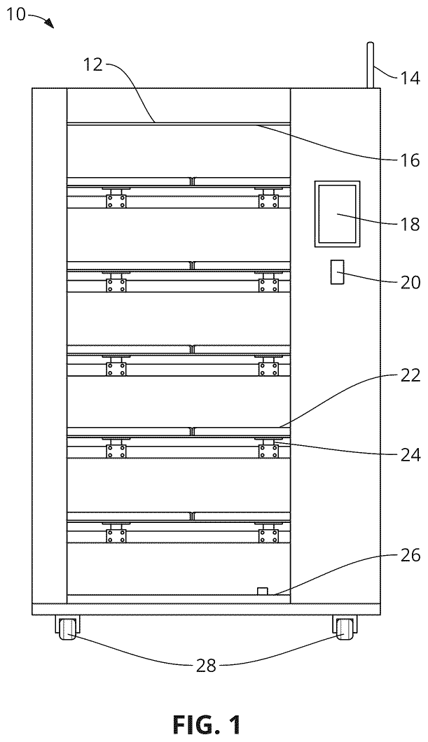

Referring to FIGS. 1 through 3, the present invention includes a cart assembly 10 or vending machine having an enclosure defining one or more product compartments for securely retrievable storing products. The cart assembly 10 provides a roller shutter door 16 that is movable between an open position and a closed position preventing access to the enclosure from outside the cart assembly 10, wherein the roller shutter door 16 is operatively associated with an authentication sensor 20 to be movable to the open position upon the verification of an authorized user.

Along an exterior surface of the cart assembly 10 is a user interface 18 comprising a processor, a memory, wherein the processor is communicatively coupled with the memory, and a communication module. The communication module enables communication with a server. The server may include at least one local server, a remote server, and a cloud server. The communication module connects (facilitated in some embodiments by way of an antenna 14) to the server through a network. The server comprises a database seamlessly integrated to the inventory management module configured to provide real-time insights accessible remotely. As used herein, a “database” is a collection of organized information that can be easily accessed, managed, and updated and contained in aggregations of data records or files.

The exterior of the cart assembly 10 may also provide the authentication sensor 20 that may or may not be part of the user interface 18. The authentication sensor 20 is operatively associated with the communication module for communicating with the inventory management module. The inventory management module is operable to receive data from the user interface 18, the authentication sensor 20 and the database.

An embodiment of the disclosure relates to a method providing steps of receiving an identification of a user and authenticating the user through the authentication sensor 20 operatively associated with the access system; moving the rollup door 16 to provide access to the enclosure and its plurality of compartments; identifying one or more products removed from the enclosure by way of the inventory management module coupled to a pluralities of scale sensors 24 operatively associated with each compartment; recording a record of access to the enclosure; and maintaining a database of transaction data comprising the products determined to be removed during user access to the enclosure by way of the inventory management module, and using transactional database and blockchain technology and a computing system to facilitate and track real-time transactions.

The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code. The software (also known as a software application, a computer program, script, or code) is written in any appropriate form of programming language, including compiled or interpreted languages. Any appropriate form, including a standalone program or a module, component, subroutine, or other unit suitable for use in a computing environment may deploy it. The software may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. Processors suitable for the execution of a computer program include, by way of example, both general and special purpose microprocessors, and any one or more processors of any appropriate kind of digital computer. The processor can receive instructions from any kind of computer memory. Moreover, another device, e.g., a mobile telephone, an access authentication card, etc. provided within the cart assembly 10 may embed a computer.

To provide for interaction with a user, a computer associated with the user interface 18 may have a display device for displaying information to the user and receiving input from the user via visual feedback, auditory feedback, or tactile feedback, graphical user interface or a Web browser through which a user may interact with an implementation, or any appropriate combination of one or more such back-end, middleware, or front-end components, may realize implementations described herein, including input transmitted through a communication network that may interconnect to the user interface 18 by way of communication networks.

The computing system may include clients and servers. A client and server are remote from each other and typically interact through a communication network. The relationship of the client and server arises by virtue of computer programs running on the respective computers and having a client-server relationship with each other.

Embodiments of the present invention may comprise or utilize a special purpose or general-purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

In addition, a non-transitory machine-readable medium and/or a system may embody the various operations, processes, and methods disclosed herein. Accordingly, the specification and drawings are illustrative rather than restrictive. Although the subject matter herein described is in a language specific to structural features and/or methodological acts, the described features or acts described do not limit the subject matter defined in the claims. Rather, the herein described features and acts are example forms of implementing the claims. Moreover, although features described herein as acting in certain combinations and even initially claimed as such, one or more features from a claimed combination may in some cases be excised from the combination, and the claimed combination may be directed to a sub-combination or variation of a sub-combination.

The computer system includes one or more processors and computer-readable media such as computer memory may practice the methods. In particular, one or more processors execute computer-executable instructions, stored in the computer memory, to perform various functions such as the acts recited in the embodiments.

As used herein, the term “recording” is the process of collecting and storing data over a period to analyze specific trends or record the data-based events/actions of a system, network, or a data environment. It enables the tracking of all interactions through which data, files or applications are stored, accessed, or modified on a storage device or application.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server.

In certain embodiments, the communication network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices, microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all aspects of the one or more embodiments described herein. In a distributed computing environment, program modules can be in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

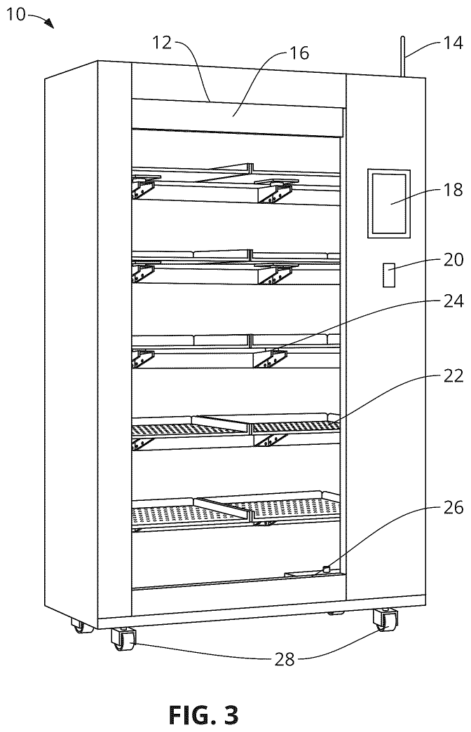

Referring to FIGS. 1 and 3, the bottom surface of each compartment may be defined by a compartment base 22, tray or bin dimensioned and shaped to be the only supporting surface provided in each compartment. Each compartment base 22 is operatively associated with at least one scale sensor 24 continuously monitoring the quantity or weight of inventory products within a compartment of the cart assembly 10 suitable for the size and weight capacity of the cart assembly 10.

Each scale sensor 24 is operable to send a weight value of each compartment base 22 to the server upon access to the enclosure. The weight value is compared with an initial weight of the relevant compartment base 22 that is retrievably stored in the database to determine if any product inventory associated with said compartment base 22 has changed.

Specifically, the present invention employs scale sensors 24 configured to accurately determine which products have been removed and in what quantities through the following methodologies and component steps.
1. Initial Stocking and Setup: When the enclosure is initially stocked, the location and weight of each item are programmed into the server. In one embodiment, the enclosure features five shelves, each with two sections/compartments, and each compartment is equipped with an individual load sensor, totaling ten scale sensors 24.
2. Product Location and Weight Recording: As products are loaded into a compartment—i.e., the shelf and section—a compartment location of each product are recorded in the back-end system/server along with a unit weight of the product (e.g., weight value). This precise mapping ensures accurate tracking of each product's location within the present invention/enclosure.
3. Load Sensor Technology: The high-precision load/scale sensors 24 continuously monitor the weight value of each section/compartment. When a product is removed, the sensor detects a change in the weight value.
4. Determining Product Removal: When a product is removed from the cart, the program computes the quantity and type of product removed based on the variation in weight and the location from which the product was taken. This information is then cross-referenced with the initial stocking data.
5. Real-time Data Integration: The data from the load/scale sensors 24 is instantly transmitted to our cloud-based inventory management software module. The software/module uses the recorded location and weight values to confirm which specific product was removed and the exact quantity.
6. Automated Alerts and Replenishment: Based on inventory thresholds (established via the inventory management software module) set within the software/module, automated alerts are generated for products that need replenishment. This ensures timely restocking and continuous availability of products.

Thereby enabling accurate and real-time inventory management, providing clear insights into product removal and replenishment needs

Each scale sensor 24 is positioned and otherwise configured to measure the weight value of the operatively associated compartment. The placement and configuration of load/scale sensors 24 within the cart assembly 10 can be adjusted to accommodate different storage layouts or weight distribution requirements. Each scale sensor 24 is coupled to the systemic computing system so that each scale sensor 24 provides input thereto. The systemic computing system may be configured to evaluate the weight value and calculate inventory data for the inventory management module. The system may, for example, first subtract the initial weight value of an associated compartment from a total weight detected by the scale sensor 24 to determine the weight of a payload within the compartment, and then from the delta determine the product or products removed, which is transmitted to the inventory management module.

Each scale sensor 24 continuously monitors the inventory within each compartment of the cart assembly 10, wherein each scale sensor 24 communicates weight value data with the inventory management software module, which may reside in a cloud platform. The inventory management software module receives data from the load/scale sensors 24 and processes it in real-time, providing insights into inventory levels. This information is accessible remotely through a cloud platform, facilitating efficient inventory management, optimization, and forecasting. The inventory management software module offers real-time tracking and cloud integration.

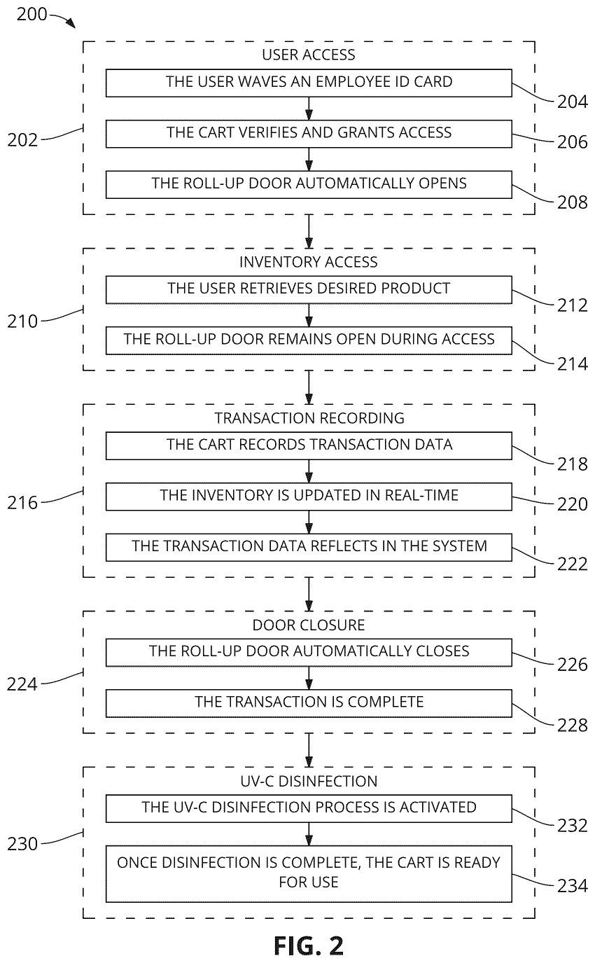

Referring to FIG. 2, the cart assembly 10 may include a sanitation module 230. The sanitation module 230 may include UV-C light sources for disinfection within the enclosure, ensuring the hygiene of all stored products. This disinfection may be triggered at specific intervals or after user interactions to maintain a sanitized environment. The sanitation module 230 is implemented based on a schedule, after each access, and/or triggered by specific events. The UV-C disinfection system can be repositioned or integrated differently within the cart to ensure effective coverage. The sanitation module 230 may activate for a predetermined period to remove any germs left by the consumer who retrieved the product. If UV-C disinfection is required, the cart assembly 10 activates the disinfection process through the user interface 18 or set it to occur automatically after each access.

In an embodiment, the enclosure may provide environmental parameters sensors to sense physical conditioning parameters comprising at least one of a temperature, a pressure, and a humidity inside the enclosure to monitor a state of preservation of the products therein. The environmental parameters sensors may be configured to send the temperature, pressure, and humidity values inside the enclosure to the server. The systemic software involves algorithms, decision-making processes, and conditional logic for tasks such as real-time inventory tracking, access control, temperature and humidity regulation, and user interaction.

The systemic processor, upon receipt of the environmental parameter sensor data providing environmental information, physical conditioning parameters, can display alerts on the display/output interface and the processor. Refrigeration and air control equipment is operatively associated with the enclosure and is controlled by systemic software to maintain and monitor optimal storage conditions for temperature and humidity-sensitive products. Logic is likely implemented to maintain set temperature and humidity levels, with if-then relationships to adjust settings as needed. Select refrigeration units, temperature gauges, and humidity monitoring systems suitable for the cart's size and intended use.

Customize settings such as temperature and humidity through the touchscreen interface based on the specific requirements of stored products initiate the refrigeration and air control equipment so that if the temperature or humidity is outside of the pre-set limits, the processor engages the refrigeration and air control equipment. Sound-absorbing foam may be strategically placed to reduce operational noise, contributing to a quieter and more user-friendly environment.

In some embodiments, a plurality of light sources 12 and 26 may be arranged along an interior of the enclosure to provide visibility into each of the one or more product compartments. The light sources may be LED lights for enhanced visibility, aiding users in locating and managing items. The plurality of light sources 12 and 26 may be controlled by logic of the systemic software involved in controlling the lighting conditions based on user interactions or certain events. LED lights may be selected for appropriate brightness and energy efficiency for installation within the cart assembly 10. The positioning and quantity of LED lights can be adapted to suit specific visibility needs or storage configurations, and for optimizing visibility and integrating the UV-C light sources to cover the entire storage area.

The cart assembly 10 utilizes the authentication sensor 20 to gain access to the enclosure by moving the operatively associated powered rollup door 16 to the open condition, ensuring security and ease of use. The authentication sensor 20 may include a proximity card reader for access control, wherein the motorized rollup door 16 is controlled automatically by the proximity card reader/authentication sensor 20 validating or authenticating a user with proper identification.

The user interface 18 may be a touchscreen monitor configured as the user interface, allowing intuitive control and interaction with the cart assembly 10 features through the systemic software providing algorithms, decision-making processes, and conditional logic for tasks such as real-time inventory tracking, access control, temperature and humidity regulation, and user interaction. The implementation may include if-then relationships, subroutines, and other logical constructs to ensure the seamless operation and coordination of the various components within the cart assembly 10.

The cart assembly 10 operates through the coordinated functionality of its individual components, working both individually and synergistically to achieve its desired function. For instance, the motorized rollup door 16 may be controlled by the authentication sensor 20 properly authenticating a user, ensuring secure access only to authorized users, thereby enhancing security and preventing unauthorized handling of inventory. Logic is implemented to control the motorized rollup door 16 based on user authentication through the proximity card reader/authentication sensor 20.

The user interface 18 serves as the user interface for interacting with the cart assembly 10. Users can access inventory information, control settings, and initiate specific functions through the touchscreen. Individually, each component plays a crucial role in fulfilling its specific function, whether it be monitoring inventory, maintaining hygiene, ensuring security, or optimizing. The logic involved in the cart assembly 10 operation spans various components and functionalities. Specifically, the user interface 18 involves user interaction logic, employing if-then relationships for menu navigation, settings adjustment, and initiating specific functions.

The scale sensors 24 incorporate logic to measure and transmit data regarding the weight and/or quantity of items in the cart assembly 10 to the cloud-based inventory management software module. The inventory management software module is the central hub of logic, incorporating algorithms for real-time inventory tracking, forecasting, and demand planning. It includes if-then relationships to trigger alerts for low stock, reorder points, and other inventory-related decisions. The inventory management software module is capable of real-time tracking and cloud integration.

The inventory management software module is the central hub of logic, incorporating advanced algorithms for real-time inventory tracking, forecasting, and demand planning. The component steps involved in gleaning and acting upon these insights include the following:
1. Initial Data Input: When the enclosure of the cart assembly 10 is initially stocked, the location and weight of each item are programmed into the server. This data forms the baseline for all subsequent inventory tracking.
2. Real-time Monitoring: The high-precision load/scale sensors 24 continuously monitor the weight of each section/compartment in the cart assembly 10. Any change in weight is instantly detected and recorded by the computing system.
3. Data Transmission: The weight data, which includes changes in weight values, from the scale sensors 24 is transmitted in real-time to our cloud-based inventory management software module. This software/module integrates the weight data and updates the inventory status immediately.
4. Product Removal Detection: When a product is removed, the inventory management software module computes the quantity and type of product based on the variation in weight values, product unit weights, and the known and identified locations of the various products. This information is cross-referenced with the initial stocking data to identify the specific product and amount removed.
5. Algorithmic Processing: The inventory management software module uses sophisticated algorithms to analyze the real-time data. These algorithms can track inventory levels, forecast future demand, and plan replenishments.
6. Triggering Alerts: The software includes if-then relationships to trigger alerts for low stock levels, reorder points, and other critical inventory-related decisions. For example, if the stock level of a particular item falls below a predefined threshold, an automatic alert is generated to prompt restocking.
7. Forecasting and Demand Planning: The software can forecast future inventory needs based on historical data and real-time usage patterns. This helps in planning for demand and avoiding stockouts.
8. Cloud Integration: All the data and insights may be stored and processed in the cloud, allowing for seamless integration and access from multiple remote devices/terminals in various locations. This ensures that inventory managers can monitor and manage inventory in real-time from anywhere.

In addition to real-time tracking and alerts, the inventory management software provides detailed reports and analytics, helping businesses make informed decisions about inventory management. These insights can include trends in product usage, seasonal demand variations, and optimal reorder quantities, further enhancing the efficiency and effectiveness of the inventory management process.

Overall, the integration of these components requires a sophisticated logic system to ensure seamless coordination and functionality, contributing to the efficiency and effectiveness of the cart assembly.

Elements of the present invention include a barcode/RFID scanning system integrated with the inventory management module to enhance inventory tracking and user interaction. An automated shelving system implementing automated shelves could improve accessibility and organization of inventory. Likewise, the Internet of Things (IoT) could enable communication with other smart devices and systems, enhancing overall integration within a larger operational context. Additional security features may include biometric authentication, could further enhance access control.

A method of using the cart assembly 10 for efficient inventory management, hygiene maintenance, and optimized storage, may include the following steps. An administrative user of the present invention may open the motorized rollup door 16 using the touchscreen interface 18 or authorized access card/authentication sensor 20 having it read a suitable identification card or the like. The administrative user may then load inventory items into the compartments provided by the cart assembly 10, ensuring proper placement and distribution so that said administrative user may utilize the touchscreen monitor to access real-time inventory information provided by the scale sensors 24 and inventory management software module.

For a consumer user, they too may use the touchscreen interface 18 or authentication sensor 20 to open the motorized door 16; for instance, consumer user may need a Proximity Card or another means of authorization, such as an IC card, code, or biometric authentication, to access the cart contents through the touchscreen interface or authentication sensor to open the motorized roller shutter door 16. Only then may that consumer retrieve a desired product, at which time the scale sensors 24 will automatically update inventory levels. The consumer user will then close the motorized door securely after retrieving products from the relevant compartment(s). Optionally activation of the UV-C disinfection again for enhanced hygiene may be automatically implemented upon the motorized door moving to the closed position.

Access the cloud platform remotely using the inventory management module to monitor inventory levels, receive alerts for low stock, and make data-driven decisions. The administrative user may reload the inventory with the same procedure, ensuring accurate tracking through load sensors. By following these steps, a user can effectively utilize the smart cart assembly 10 for streamlined inventory management, access control, and optional features like UV-C disinfection and climate control, addressing the identified problems and optimizing the overall supply chain process.

The core concepts and components of the Smart Cuboid Cart can potentially be adapted for use in different ways or in other fields of technology. While the primary application is in mobile supply cart and inventory management, certain elements may find relevance in other contexts; for instance, as UV-C disinfection and controlled environment settings of the present invention, could be adapted for storing medical supplies, ensuring a sanitized and climate-controlled environment, such as laboratory sample storage. The controlled conditions provided by the refrigeration equipment and environmental monitoring system could be utilized for storing sensitive laboratory samples. The climate control features could be applied to create a controlled environment for preserving artifacts in museums or archives. The inventory tracking and controlled access features could be beneficial for managing and securing books in a library setting. The controlled environment and access features could be adapted for storing sensitive electronic components that require specific conditions. The concept of controlled access and environmental monitoring could be applied to ensure optimal conditions for equipment storage in a data center.

The inventory management system could be integrated with warehouse robotics for automated inventory handling in large-scale storage facilities. The concept of real-time inventory tracking and remote management could be adapted for autonomous vehicles transporting materials within a facility.

While the primary application is a mobile supply cart, the modular and adaptable nature of certain features could potentially find utility in various technological fields, particularly where controlled access, environmental conditions, and inventory management would be a boon.

The present invention is an apparatus designed as a mobile supply cart with integrated features for efficient inventory management, access control, and optional elements such as UV-C disinfection and climate control. While its primary function is not to produce other physical products, it serves as a technological solution that streamlines inventory processes, enhances security, and ensures optimal storage conditions for various items.

The value of the invention lies in its ability to provide a tangible and practical solution for businesses or organizations seeking improved inventory management, hygiene maintenance, and controlled access within a mobile cart framework. The Smart Cuboid Cart is a product that incorporates various technologies to address specific challenges in the supply chain and storage processes.

The cart assembly 10 has wheels 28, making the cart assembly 10 rollable along a supporting surface.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A system comprising:
a product enclosure comprising:
a plurality of product compartments, each product compartment supporting one or more products;
a processor;
a memory, wherein the processor is communicatively coupled with the memory;
for each product compartment, a scale sensor configured to output a weight value indicative of a weight of the one or more product, operatively associating the base and the processor; and
an inventory management module and wherein the processor is operable to:
for each product compartment, generate a map of the one or more products compartment, wherein the map provides a location indication of each said product;
continuously make a real-time determination of a quantitative change in the one or more products based on a change in the outputted weight value of one or more of the plurality of product compartments and an identification of each location indication associated with said change in the outputted weight value, and
maintain a database comprising the real-time determination.

2. The system of claim 1, wherein the plurality of product compartments is inaccessible from an exterior environment but for an opening in an open condition; and a roller door movable between the open condition and a closed condition preventing access to the plurality of product compartments.

3. The system of claim 2, wherein the product enclosure further comprises an authentication sensor operatively associated with the roller door such that movement to the open condition requires verification of the authentication sensor.

4. The system of claim 3, wherein when the product enclosure is stocked with a product, the location indication and a unit weight of each product is received by the server as an inventory stocking data.

5. The system of claim 4, wherein a summation, for each product compartment, of the unit weights for the one or more products is a baseline for the real-time determination of the change in the outputted weight value.

6. The system of claim 5, wherein the real-time determination is based on the inventory stocking data.

7. The system of claim 6, wherein the inventory management module is configured to track a level for each product.

8. The system of claim 7, wherein the inventory management module is configured to forecast a future demand for each product based on the real-time determination.

9. The system of claim 8, wherein the inventory management module is configured to plan a replenishment for each product based on the real-time determination and an inventory threshold for said product, wherein the inventory threshold is received by the server.

10. The system of claim 9, wherein the inventory management module is configured to transmit alerts for each product based on the real-time determination and the inventory threshold for said product.
